(19) United States
(12) Patent Application Publication
(10) Pub. No.: US 2007/0192319 A1
(43) Pub. Date: Aug. 16, 2007

(54) Search engine application with ranking of results based on correlated data pertaining to the searcher

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,886

(22) Filed: Jan. 29, 2007

Related U.S. Application Data
(60) Provisional application No. 60/762,514, filed on Jan. 27, 2006.

(51) Int. Cl. G06F 7/00

(52) U.S. Cl. 707/7

(57) ABSTRACT

A method of providing users with improvements in the acquisition and display of content from the World Wide Web is provided in respect of users searching the World Wide Web. The method exploits the storing of user dependent information, including both limited to their personal information, personal contacts, personal preferences, and consumer related history data. The resulting user dependent information allowing the ranking of retrieved search results from an inquiry provided by the user according to their personal data and preferences. Accordingly the method provides for the user to combining the results from a single query to multiple search engines and display them as a single ranked list. According to another embodiment of the invention the method allows for automatically refining the search iteratively to provide results with high relevance to the user or of a manageable quantity to review.

This application claims the benefit of U.S. Provisional Application 60/762,514, filed on Jan. 27, 2006, the entire contents of which are incorporated herein by reference.

### FIELD OF THE INVENTION

The instant invention relates generally to data searching, and more particularly to a method for reducing search space complexity based on correlated data pertaining to the searcher.

### BACKGROUND

Over the past few years the use, content and diversity of information accessible on or through the Internet, or World Wide Web (WWW), has increased dramatically and increases substantially every single hour. Ranging from commercial retailers, to Government departments, help and support resources for health or addictions, chat rooms, music, video, and more recently personal websites and content provision by way of user-generated websites where entries are made in journal style, commonly call blogs, and concepts such as YouTube™ where users upload their own personal videos for viewing by any other user of the website. To help users navigate and find information in this diverse and otherwise unmapped network of storage sites, companies have developed and provide Network Browsers or Search Engines (hereinafter, search engine), such as Google™, Yahoo™, Alta Vista™, Ask™, and Internet Explore™. By simply entering a keyword, series of keyword or a phrase the search engine interrogates a database of its own creation and provides the user with a list of references from the database that correlate to the users keywords etc.

The search engines work by storing information about the large number of web pages, websites, images, video segments, text content, etc., which they retrieve from the WWW themselves. These pages are retrieved by a web crawler (sometimes also known as a spider) that is an automated web browser that follows every link it finds and retrieves the information from these links in doing so. Exclusions can be made, but typically the entire content of every page accessed is retrieved. The contents of each page are then analyzed to determine how it should be indexed (for example, words are extracted from the titles, headings, or special fields called meta tags). Data about the web pages are stored in index databases for use in later queries. Some search engines, such as Google™, also store all or parts of the source pages (referred to as a page cache) as well as information about the web pages, whereas others, such as Alta Vista™, store every word of every page they find. Cache has benefits in that retrieval can be faster as no reformatting is required to provide the page to the user, and the cached page always holds the actual retrieved text since it is the one that was actually indexed, so it can be very useful when the content of the current page has been updated and the search terms are no longer in it. This problem might be considered to be a mild form of linkrot, wherein links to information become out of date. Google™'s handling of it increases user usability by satisfying user expectations that the search terms will be on the returned web page. This satisfies the principle of least astonishment since the user normally expects the search terms to be on the returned pages. Increased search relevance makes these cached pages very useful, even beyond the fact that they may contain data that may no longer be available elsewhere.

When a user comes to the search engine and makes a query, typically by giving key words, the engine looks up the index and provides a listing of best-matching web pages according to its criteria, usually with a short summary containing the document's title and sometimes parts of the text. Most search engines support the use of the Boolean terms AND, OR and NOT to further specify the search query. An advanced feature is proximity search, which allows users to define the distance between keywords.

The usefulness of a search engine depends on the relevance of the result set, or search space, it returns. While there may be millions of web pages that include a particular word or phrase, some pages may be more relevant, popular, or authoritative than others. Most search engines employ methods to rank the results to provide the “best” results first. How a search engine decides which pages are the best matches, and what order the results should be shown in, varies widely from one engine to another, and is not dependent upon any aspect of the user other than the terms they entered. Hence, whilst the goals of users in retrieving information are different their use of the same keywords means they start from the same retrieved list of web pages. Despite the explosion of content on the Internet, and the changes in the needs of the user, the search engines have evolved little.

Most Web search engines are commercial ventures supported by advertising revenue and, as a result, some employ the controversial practice of allowing advertisers to pay money to have their listings ranked higher in search results. Those search engines that do not accept money for their search engine results make money by running search related ads alongside the regular search engine results. The search engines make money every time someone clicks on one of these ads.

In a computer system such as the Internet, a plurality of users provide, on a daily basis, various types of information relating to their preferences, habits, demographic identity, etc. Such information can be their list of bookmark or favorite websites, databases of book bought or read, audio-visual media bought or acquired, purchases made, contents of their blogs or other blogs, personal contacts within their electronic databases associated with their cellphone, PDA, email etc, and other sources.

It is also the case that, with every click of a mouse button, the users are providing some form of information about themselves. For instance, by selecting certain music compact disks (CDs) from a list to view, reading reviews for certain movies, reading opinions via sites, etc., the user is providing a wealth of information.

It would therefore be beneficial if a search engine returned results based upon aspects of the user such that users retrieving information with the same keywords now are presented with information where the retrieved search results have been filtered further based upon personally derived user data.

### SUMMARY OF EMBODIMENTS OF THE INSTANT INVENTION

According to an aspect of the instant invention there is provided a method of providing content to a user, comprising: storing user data for the user, the user data comprising at least one of user consumer-history and user personal information relating to the user; receiving an initial search query from the user; determining a set of initial search results, each search result within the initial set of search results associated with content that is stored on at least one of a plurality of computer systems and correlating at least in part with the initial search query; sorting the set of initial search results by ranking the set of initial search results such that a search result within the set of initial search results that is associated with content that is most relevant to the user data is ranked highest; and displaying the ranked initial search results to the user.

In accordance with an aspect of the invention there is provided a computer-readable storage medium having stored thereon computer-executable instructions for a method of providing search results to a user, the method comprising: storing user data for the user, the user data comprising at least one of user consumer-history and user personal information relating to the user; receiving an initial search query from the user; determining a set of initial search results, each initial search result being associated with content that is stored on at least one of a plurality of computer systems and correlating at least in part with the initial search query from the user; sorting the set of initial search results by ranking the initial search results such that an initial search result that is associated with content that is most similar to the user data of the user is ranked highest; and displaying the ranked initial search results to the user.

In accordance with an aspect of the invention there is provided a method of providing content that is stored on a computer system, comprising: (a) storing first data that is indicative of personal information of a user of the computer system, the personal information for use in a plurality of different searches; (b) receiving an initial search query from the user of the computer system; (c) determining an initial search space comprising a plurality of search results each being associated with the first data and the initial search query in a known fashion; and, (d) displaying the ranked initial search results to the user.

In accordance with an aspect of the invention there is provided a computer-readable storage medium having stored thereon computer-executable instructions for performing a method of searching for content that is stored on a computer system, the method comprising: storing first data that is indicative of personal information of a user of the computer system; receiving an initial search query from the user of the computer system; determining an initial search space comprising a plurality of search results each being associated with content stored on the computer system; correlating the stored first data with the plurality of search results, so as to determine similarities between the personal information relating to the user and the content stored on the computer system in association with the said search results; based on the determined similarities, ranking the initial search results such that an initial search result that is associated with content that is most similar to the personal information of the user is ranked highest; and, displaying the ranked initial search results to the user.

### BRIEF DESCRIPTION OF THE DRAWINGS

Exemplary embodiments of the invention will now be described in conjunction with the following drawings, in which similar reference numerals designate similar items:

FIG. 1 illustrates a prior art search result of performing a web based search by a user seeking an item for purchase.

FIG. 2 illustrates a prior art search result of increasing the specificity of a prior art search by a user on a second web search engine.

FIG. 3A illustrates a prior art search result of increasing the specificity of a prior art search by a user on the first web search engine.

FIG. 3B illustrates the three web pages reached from the prior art search described in respect of FIG. 2.

FIG. 4 illustrates a typical user web based approach according to the prior art using multiple search engines.

FIG. 5 illustrates an association of user preferences with a user according to an embodiment of the invention.

FIG. 6 illustrates a result of performing a search according to an embodiment of the invention using user preferences as outlined in respect of FIG. 5.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

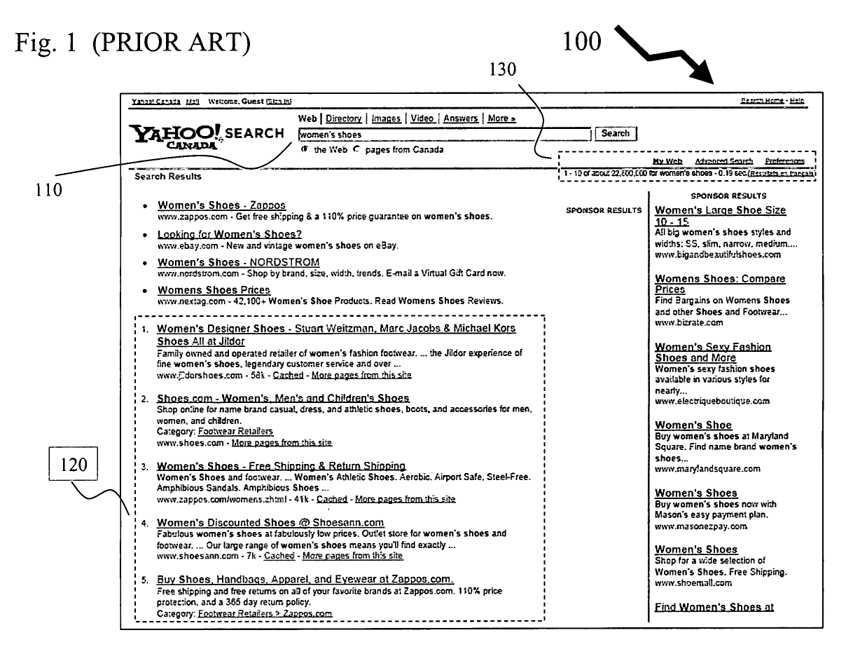

Presented in FIG. 1 is a prior art search engine report 100 from the Yahoo!™ executed by a user seeking a pair of women's leather footwear, which coordinate with their existing wardrobe. The search using the Yahoo!™ was made using the keywords “women's shoes” 110 and returns 22,800,000 “hits” within a search time of 0.19 seconds 130. Rather a daunting list to filter through to find the right boots. The “hits” are shown as list entries 120 on the search engine report 100. Selection of an element of underlined text associated with one of the text entries 120 results in the web search engine extracting the Universal Resource Locator (URL) associated with that specific text entry 120 and subsequently displays the referenced web page identified by the URL.

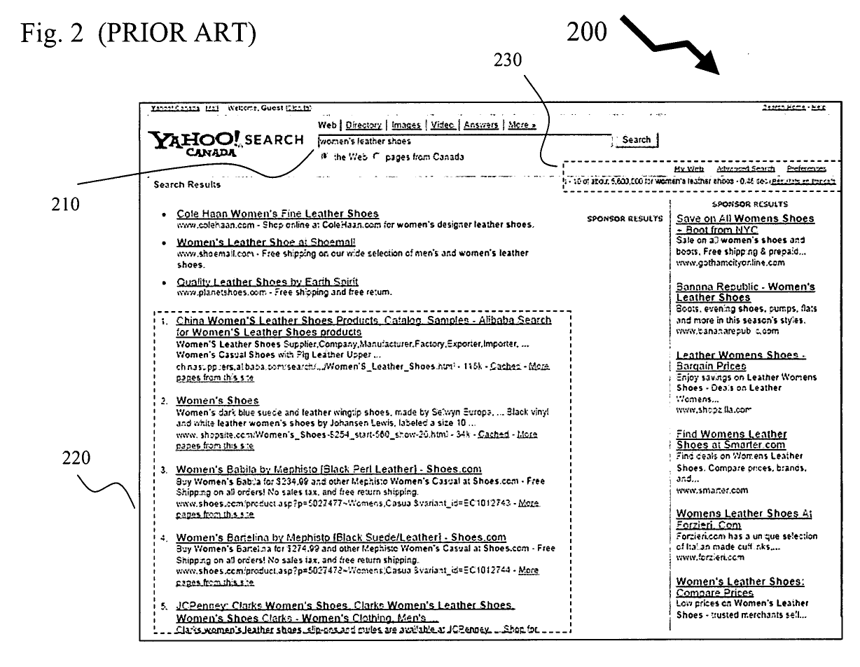

The user feeling that they do not wish to search through this list enters refined text “women's leather shoes” 210 into the search engine and returns the result page 200, as shown in FIG. 2. Now the results line indicator 230 shows 5,600,000 “hits” in 0.46 seconds. Fewer entries 220 therefore, but still an issue for the user to search more than a few entries.

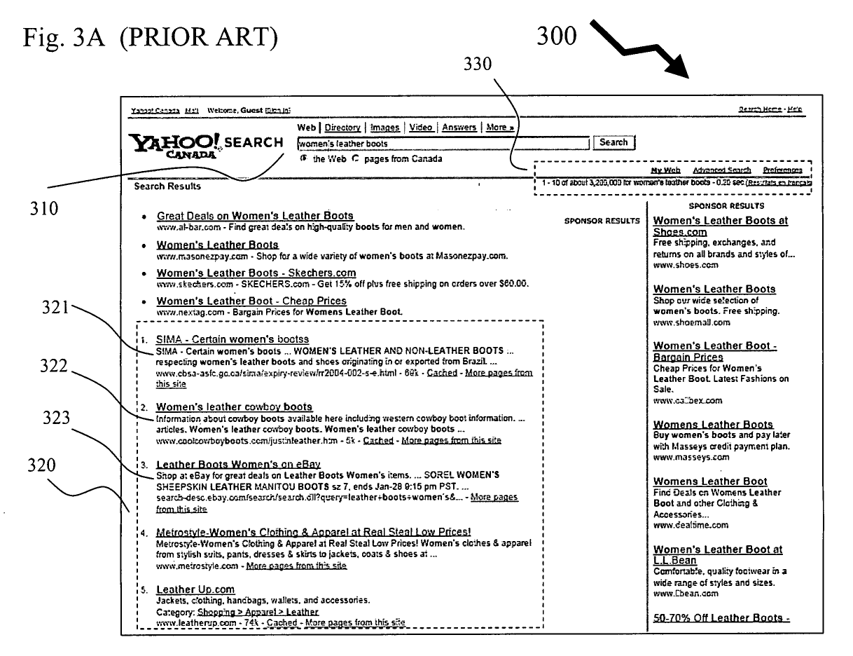

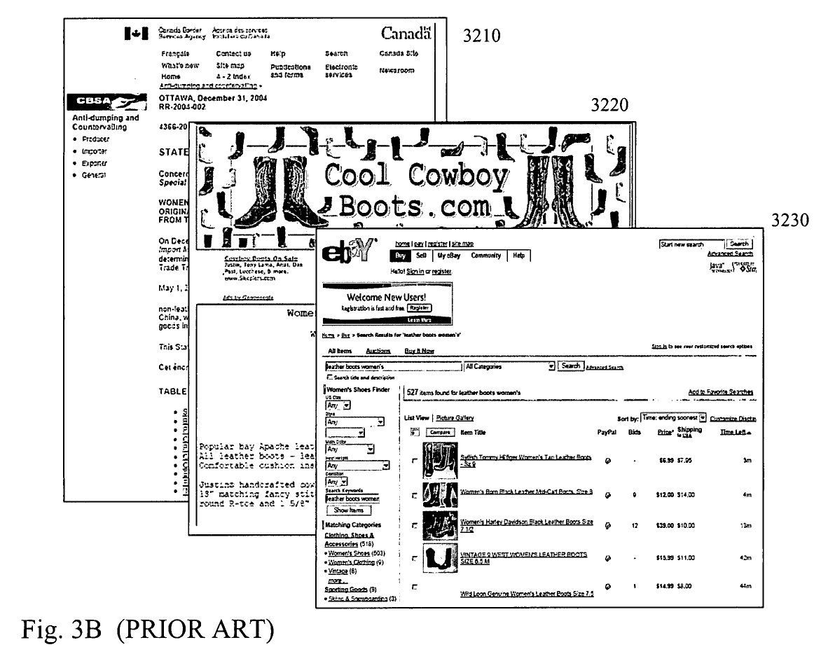

Deciding that in fact they wish to refine their search from shoes to boots, the user provides refined text “women's leather boots” 310 in to the search engine and returns results page 300, as shown in FIG. 3A. Now the results line indicator 330 indicates 3,200,000 “hits” in 0.2 seconds. Fewer but still too broad for a sensible search to be made.

As a result, the user accesses the top three “hits” as shown in respect of FIG. 3B using the search results page 300. Therefore the user selects the first web link 321, which results in the webpage 3210 being retrieved. This is in fact a Canadian Government advisory notice in respect of regulations affecting the import and export of leather goods. Obviously not retrieving information they were seeking the user now returns to the results page 300 and selects the second web link 322, which results in the webpage “Cool Cowboy Boots.com” 3220 being displayed. Deciding that these are not the correct style, the user again returns to the results page 300 and selects the third web link 323.

In this instance the third web link 323 results in a section of the ebaY™ online auction website 3230 being displayed as relates to women's leather boots. This list providing 527 results, but many of these are auctions are due to expire shortly, do not present photographs to ease the users browsing of the results page, and requires extended searching to decide if the third web link 323 has actually led to something worthwhile. Clearly, this search leaves the user without the information they were seeking, and probably frustrated, potentially enough to make them simply walk into a store and buy their footwear to the detriment of providers outside the users locality who actually offer boots the user would really love with easy purchase online and shipping methods.

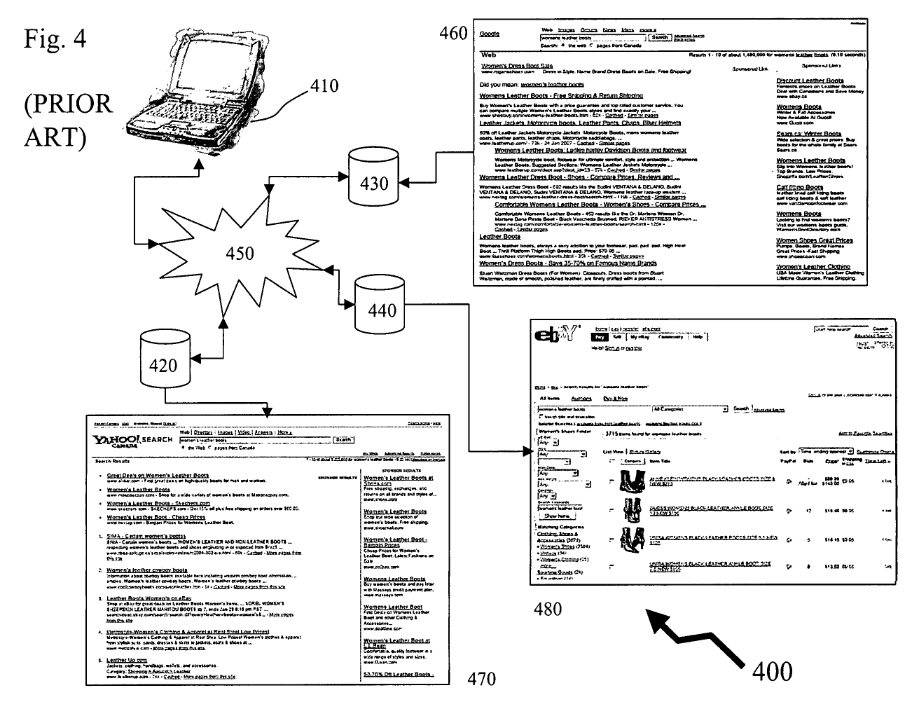

However, the user perseveres in their online search, and seeking more information accesses multiple commercial retailers as displayed in reference to FIG. 4. Here the user is accessing from their personal computer 410 the World Wide Web 450 and accessing multiple retailers websites 460 through 480. Firstly, the user accesses Google™ through a first web host server 430 resulting in Google webpage 460 being presented to the user. Now the user accesses ebaY™ again through a second web host server 440 from which they extract an eBay webpage 480, thereby being provided with information in a different display format making correlation to the Google webpage 460 for seeking information and the best deal a difficult and time consuming task.

Next the user accesses the Yahoo!™ website from the second web host server 420 and obtains Yahoo webpage 470. Clearly such searching using current software applications makes obtaining the desired information for the user difficult.

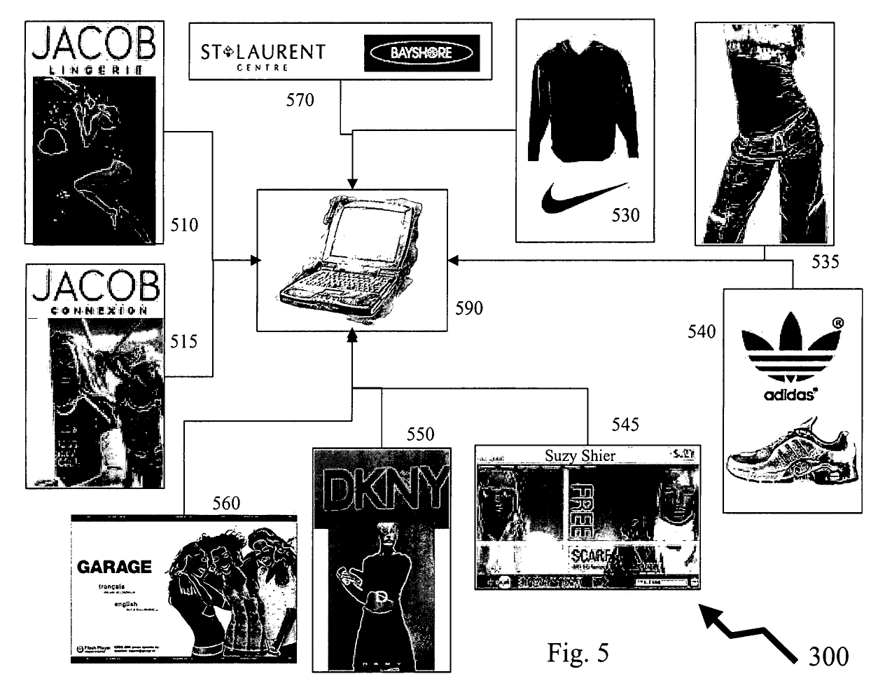

As mentioned supra the user is seeking footwear that coordinates with their wardrobe. But evidently from the prior art results presented in respect of prior art search engine results as depicted in respect of FIGS. 1 through 4. According to an embodiment of the invention the user enters data associated with their wardrobe, and optionally their preferences as shown in respect of process 500 of FIG. 5. As shown the user has a computer 590 into which they enter personnel information in respect of their wardrobe items 510 through 560, being specifically stores from which they have purchased, and shopping mall information 570, which relates to two local malls to the user.

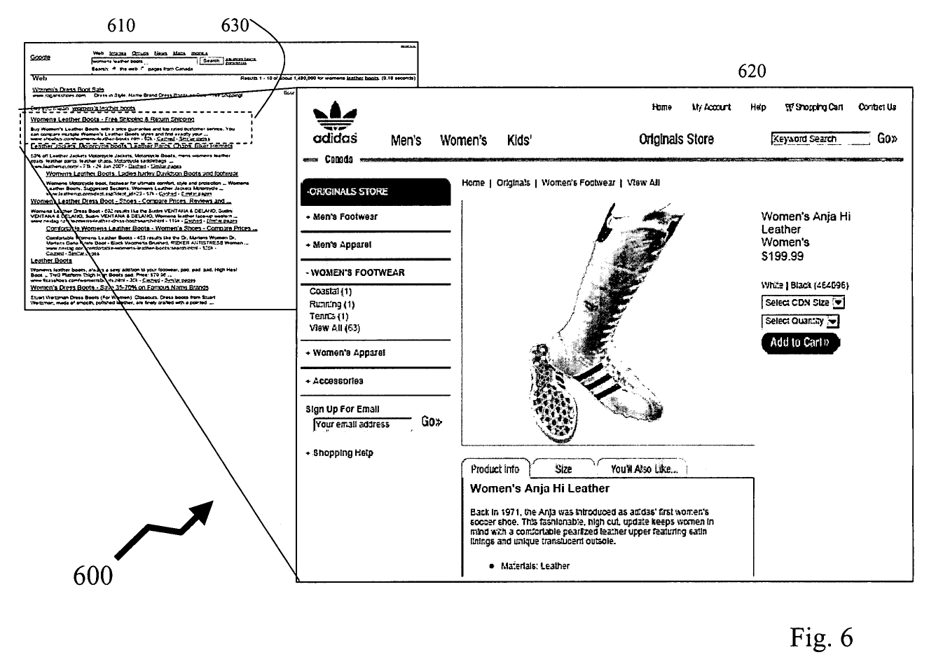

The wardrobe items are ‘Jacob Lingerie” 510, “Jacob Connexion” 515, “Nike” clothing 530, “CARGO jeans” 535, “Adidas” shoes 540, “Suzy Shier” 545, “DKNY” 550, and “Garage” 560. These fields are entered into the computer 590 of the user and accessed by the web search engine from a subsequent search as shown in FIG. 6. The user preferences are stored locally within the users computer 590 or alternatively are stored remotely at a server for subsequent extraction and use.

In respect of FIG. 6, the user having now established their preferences reexecutes the web search process on a particular website, resulting in the correlated results page 610. The search engine upon retrieving the URL links performs a correlation of these links with user preference information entered previously. In this manner, for example, the process returns 250 “hits,” a manageable quantity. It would be possible to further reduce the quantity of results by decreasing the search space or increasing the search terms. Further reduction in the quantity of results is available by, for example, varying a threshold of correlation. Now, the user selects the first returned link 630 which results in the return of webpage 620, this being a page from the Adidas website. The returned page being a women's leather boot in the form of a stylized football shoe. Clearly comparing the “Adidas Anja Hi Leather” boots to items of clothing and their accompanying stores as depicted in FIG. 5 shows a significant similarity.

Whilst the embodiments described above have been made in reference to the purchasing of a consumer item, embodiments allow user preferences to be exploited in searching for any information from the World Wide Web. As an example a search for a hotel for a vacation to Sydney could be refined to account for the users love of opera, as evidenced by their music collection, their enjoyment of food, as evidenced from their subscriptions to the BBC Good Food Magazine and online purchases of cookbooks, utensils and ingredients and thereby provide high ranking to hotels located between the Sydney Opera House and the culinary district surrounding Stanley Street. As such the user achieves a search specific to their preferences.

In accordance with another embodiment, a user defines a set of criteria that define a search space. For example, purchases, preferences and ratings of purchases and interests are provided to a database. The set of criteria is then mapped in an N dimensional (N>2) space. The set of criteria is then correlated with the entire search space to find those entries within the search space that correlate most closely with the set of criteria. When a search is performed, search results are either filtered or ranked based on a proximity to the set within the N-dimensional space and a correlation with the set.

For example, as noted above a user's preference for opera is evidenced by their collection of opera music as stored in an online catalogue of their music. When the user searches for information on “musical performances,” the system automatically ranks opera performances higher than others. If the user has indicated that filtering of the search results should be performed, then non-opera results are removed. Alternatively, the non-opera results are relegated to the lower section of the search result list.

In another embodiment, a user is provided an opportunity to rate Web sites that they browse. Correlated the ratings of many other users with the ratings of the user creates an overall rating system for Web sites that is specific to the user. The correlated ratings are then used for ranking or alternatively for filtering of search results.

Numerous other embodiments may be envisioned without departing from the spirit and scope of the invention.

What is claimed is:

1. A method of providing content to a user, comprising:
storing user data for the user, the user data comprising at least one of user consumer-history and user personal information relating to the user;
receiving an initial search query from the user;
determining a set of initial search results, each search result within the initial set of search results associated with content that is stored on at least one of a plurality of computer systems and correlating at least in part with the initial search query;
sorting the set of initial search results by ranking the set of initial search results such that a search result within the set of initial search results that is associated with content that is most relevant to the user data is ranked highest; and
displaying the ranked initial search results to the user.

2. A method according to claim 1 wherein most relevant is most similar.

3. A method according to claim 1 wherein;
determining a set of initial results comprises receiving primary results from at least one of a plurality of result providers and combining the primary results to provide the initial results.

4. A method according to claim 2 wherein;
combining the primary results comprises removing duplicate content.

5. A method according to claim 2 wherein;
combining the primary results comprises correlating the primary results according to a predetermined process.

6. A method according to claim 5 wherein;
the predetermined process comprises a process determined at least in dependence upon an aspect of the user data.

7. A method according to claim 6 wherein determining in dependence upon an aspect of the user data comprises determining in dependence upon preferences within the user data associated with sources of content.

8. A method according to claim 1 wherein sorting the initial results comprises sorting the initial results in dependence of a priority value associated with an aspect of the user data.

9. A method according to claim 1 comprising:
associating a score with each search result within the set of initial search results, the score determined in dependence upon at least the content of the search result and the user data.

10. A method according to claim 9 comprising:
filtering an initial search result from the set of initial search results in dependence upon at least the score and a predetermined score threshold.

11. A method according to claim 1 comprising:
storing the initial search results according to a predetermined format, the predetermined format supporting subsequent re-sorting of the initial search results based upon a variation of an aspect of the user data.

12. A method according to claim 11 wherein the variation of an aspect of the user data is provided in response to a prompt provided to the user.

13. A method according to claim 11 wherein the variation of an aspect of the user data is provided by subsequent activities of the user.

14. A method according to claim 1 wherein displaying the ranked initial search results comprises mapping the ranked initial search onto a three dimensional surface.

15. A method according to claim 14 wherein mapping onto the three dimensional surface comprises mapping the initial search results in dependence upon at least the ranking of the initial search result, a correlation therebetween, and an aspect of the user data.

16. A method according to claim 14 wherein mapping onto the three dimensional surface comprises mapping the initial search results in dependence upon an input from the user.

17. A computer-readable storage medium having stored thereon computer-executable instructions for a method of providing search results to a user, the method comprising:
storing user data for the user, the user data comprising at least one of user consumer-history and user personal information relating to the user;
receiving an initial search query from the user;
determining a set of initial search results, each initial search result being associated with content that is stored on at least one of a plurality of computer systems and correlating at least in part with the initial search query from the user;
sorting the set of initial search results by ranking the initial search results such that an initial search result that is associated with content that is most similar to the user data of the user is ranked highest; and
displaying the ranked initial search results to the user.

18. A method of providing content that is stored on a computer system, comprising:
(a) storing first data that is indicative of personal information of a user of the computer system, the personal information for use in a plurality of different searches;
(b) receiving an initial search query from the user of the computer system;
(c) determining an initial search space comprising a plurality of search results each being associated with the first data and the initial search query in a known fashion; and,
(d) displaying the ranked initial search results to the user.

19. A method according to claim 18 comprising:
(c1) ranking the plurality of search results in dependence upon the first data.

20. A method according to claim 19 wherein an initial search result that is associated with content that is most relevant to the first data is ranked highest.

21. A method according to claim 19 wherein step (c1) further comprises:
refining the initial search query based upon assessing the ranked initial search results; and repeating steps (c) to (d) until a predetermined criterion is satisfied.

22. A method according to claim 21 wherein refining the initial search query comprises at least one of adding, replacing, and removing an element of the initial search query.

23. A method according to claim 22 wherein refining comprises replacing the element with a new element determined in dependence upon a predetermined subset of the ranked initial search results.

24. A method according to claim 22 wherein an element is selected from a group comprising a Boolean operation to apply to search terms, a language, a file format, a domain extension, a geographic indicator, a content filter, and usage rights

25. A method according to claim 18 comprising:
(e) removing search results upon from the set of initial search results when associated with a section of a search result for which the content provider has financially incentivized its placement.

26. A computer-readable storage medium having stored thereon computer-executable instructions for performing a method of searching for content that is stored on a computer system, the method comprising:
storing first data that is indicative of personal information of a user of the computer system;
receiving an initial search query from the user of the computer system;
determining an initial search space comprising a plurality of search results each being associated with content stored on the computer system;
correlating the stored first data with the plurality of search results, so as to determine similarities between the personal information relating to the user and the content stored on the computer system in association with the said search results;
based on the determined similarities, ranking the initial search results such that an initial search result that is associated with content that is most similar to the personal information of the user is ranked highest; and,
displaying the ranked initial search results to the user.
